(19) United States
(12) Patent Application Publication
(10) Pub. No.: US 2022/0386091 A1
(43) Pub. Date: Dec. 1, 2022

(54) MOTORCYCLE MONITORING SYSTEM

(71) Applicant: Lear Corporation, Southfield, MI (US)

(72) Inventors: Samer RAJAB, Novi, MI (US); Radovan MIUCIC, Beverly Hills, MI (US)

(73) Assignee: Lear Corporation, Southfield, MI (US)

(21) Appl. No.: 17/332,341

(22) Filed: May 27, 2021

(51) Int. Cl. H04W 4/40; H04W 4/029; H04W 4/12; H04W 4/90

(52) U.S. Cl. CPC H04W 4/40; H04W 4/029; H04W 4/12; H04W 4/90

(57) ABSTRACT

A vehicle-to-everything (V2X) communication system is provided with a user interface to display content and adapted to mount within a host vehicle (HV). At least one transceiver receives input indicative of a motorcycle position by V2X communication; and receives input indicative of an HV position and an HV turn signal status. A processor is programmed to: generate content on the user interface representing the HV; determine a time-to-contact (TTC) between the HV and a motorcycle based on the input; and generate a warning message on the user interface indicative of the motorcycle position relative to the HV in response to the HV turn signal status and the TTC being less than a threshold TTC value.

### TECHNICAL FIELD

One or more embodiments relate to a vehicle system and method for monitoring a position of a remote vehicle relative to a host vehicle.

### BACKGROUND

A vehicle may communicate with other nearby objects to collect information about its surroundings. Such communication may include vehicle-to-vehicle (V2V) communication, vehicle-to-motorcycle (V2M) communication, vehicle-to-infrastructure (V2I) communication, vehicle-to-network (V2N) communication, vehicle-to-pedestrian (V2P) communication, vehicle-to-device (V2D) communication, and vehicle-to-grid communication (V2G). This communication may be collectively referred to as vehicle-to-everything (V2X) communication. V2X communication presents an opportunity to mitigate the risk of accidents involving passenger vehicles and motorcycles by monitoring the location of motorcycles relative to a passenger vehicle and presenting this information to the driver of the passenger vehicle.

### SUMMARY

In one embodiment, a vehicle-to-everything (V2X) communication system is provided with a user interface to display content and adapted to mount within a host vehicle (HV). At least one transceiver receives input indicative of a motorcycle position by V2X communication, and receives input indicative of an HV position and an HV turn signal status. A processor is programmed to: generate content on the user interface representing the HV; determine a time-to-contact (TTC) between the HV and a motorcycle based on the input; and generate a warning message on the user interface indicative of the motorcycle position relative to the HV in response to the HV turn signal status and the TTC being less than a threshold TTC value.

In another embodiment, a vehicle communication system is provided with at least one transceiver positioned in a host vehicle (HV) and adapted to receive input indicative of a motorcycle position by vehicle-to-everything (V2X) communication, and to receive input indicative of an HV position and an HV turn signal status. A processor is programmed to: generate content on a user interface representing the HV; determine a time-to-contact (TTC) between the HV and the motorcycle based on the input; and generate a warning message on the user interface indicative of the motorcycle position relative to the HV in response to the turn signal status being active and the TTC being less than a threshold TTC value.

In yet another embodiment, a method for monitoring a motorcycle position is provided. Input indicative of a motorcycle position is received by vehicle-to-everything (V2X) communication. Input indicative of a host vehicle (HV) position and an HV turn signal status is received. Content is generated on a user interface representing a host vehicle (HV). A time-to-contact (TTC) between the HV and a motorcycle is determined based on the input. A warning message is generated on the user interface indicative of the motorcycle position relative to the HV in response to the turn signal status and the TTC being less than a threshold TTC value.

### BRIEF DESCRIPTION OF THE DRAWINGS

FIG. 1 is a top schematic view of a host vehicle with a vehicle system for monitoring remote vehicles.

FIG. 2 is a detailed schematic view illustrating communication between the host vehicle, remote vehicles, and a structure, according to one or more embodiments.

FIG. 3 is a diagram illustrating remote vehicle positions relative to the host vehicle.

FIG. 4 is a front elevation view of a user interface, illustrating an advisory message including images representing the remote vehicle located ahead of the host vehicle.

FIG. 5 is another front elevation view of the user interface, illustrating an advisory message including images representing the remote vehicle located behind the host vehicle.

FIG. 6 is another front elevation view of the user interface, illustrating a warning message including images representing the remote vehicle performing a passing maneuver on the right side of the host vehicle.

FIG. 7 is a flow chart illustrating a method for monitoring remote vehicles.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

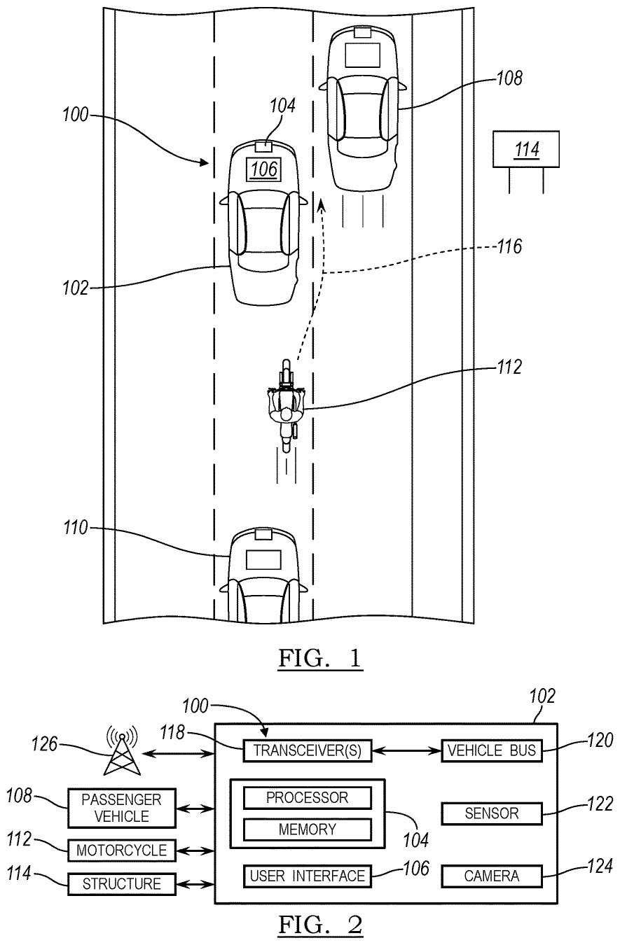

With reference to FIG. 1, a vehicle system for monitoring remote vehicles is illustrated in accordance with one or more embodiments and is generally referenced by numeral 100. The vehicle system 100 is depicted within a host vehicle (HV) 102. The vehicle system 100 includes a controller 104 and a user interface 106. The HV 102 is illustrated travelling proximate to three remote vehicles (RVs): a first passenger vehicle 108, a second passenger vehicle 110, and a motorcycle 112. The term “motorcycle” is defined herein as a two-wheeled motorized vehicle. The HV 102 may communicate with one or more of the RVs, e.g., by vehicle-to-vehicle (V2V) communication or vehicle-to-motorcycle (V2M) communication. The HV 102 may also communicate with a structure, e.g., a sign 114, by vehicle-to-infrastructure (V2I) communication.

The controller 104 receives input signals indicative of one or more driving characteristic of each RV 108, 110, 112 and determines a position and driving path of each RV. The controller 104 compares the driving path of each RV to the driving path of the HV 102 to determine if they will intersect, and if so, transmits information to the user interface 106, which in turn conveys the information to the driver in real-time. For example, the controller 104 may determine that the motorcycle 112 is passing on the right of the HV 102, as generally referenced by numeral 116, and transmit information indicative of an advisory or warning message to the user interface 106 to display to the driver.

Referring to FIG. 2, the vehicle system 100 includes one or more transceivers 118 for communicating with other systems of the HV 102. The transceivers 118 may receive input that is indicative of present operating conditions of various systems of the HV 102, e.g., an engine, transmission, navigation system, brake systems, etc. (not shown). Each input may be a signal transmitted directly between the transceiver 118 and the corresponding vehicle system, or indirectly as data over a vehicle communication bus 120, e.g., a CAN bus. For example, the transceivers 118 may receive input such as vehicle speed, turn signal status, brake position, vehicle position, and steering angle over the vehicle communication bus 120.

The transceivers 118 may also receive input that is indicative of the environment external to the HV 102. For example, the HV 102 may include sensors 122, e.g., light detection and ranging (Lidar) sensors, for determining the distance of objects external to the HV 102. The HV 102 also includes one or more cameras 124 for monitoring the external environment.

The vehicle system 100 also includes one or more transceivers 118 for communicating with other vehicles and structures. The vehicle system 100 of the HV 102 may use the transceivers 118 for communicating directly with one or more of the RVs, 108, 110, 112 or the sign 114 by vehicle-to-vehicle (V2V) communication, vehicle-to-motorcycle (V2M) communication, vehicle-to-infrastructure (V2I) communication, or collectively as vehicle-to-everything (V2X) communication.

The vehicle system 100 may use WLAN technology to form a vehicular ad-hoc network as two V2X devices come within each other's range. This technology is referred to as Dedicated Short Range Communication (DSRC), which uses the underlying radio communication provided by IEE 802.11p. The range of DSRC is typically about 300 meters, with some systems having a maximum range of about 1000 meters. DSRC in the United States typically operates in the 5.9 GHz range, from about 5.85 GHz to about 5.925 GHz, and the typical latency for DSRC is about 50 ms. Alternatively, the vehicle system 100 may communicate with another V2X device using cellular V2X (C-V2X), which may use a cellular network 126.

Each V2X device may provide information indicative of its own status to other V2X devices. Connected vehicle systems and V2V and V2I applications using DSRC rely on the Basic Safety Message (BSM), which is one of the messages defined in the Society of Automotive standard J 2735, V2X Communications Message Set Dictionary, July 2020. The BSM is broadcast from vehicles over the 5.9 GHz DSRC band, and the transmission range is on the order of 1,000 meters. The BSM consists of two parts. BSM Part 1 contains core data elements, including vehicle position, heading, speed, acceleration, steering wheel angle, and vehicle classification (e.g., passenger vehicle or motorcycle) and is transmitted at an adjustable rate of about 10 times per second. BSM Part 2 contains a variable set of data elements drawn from an extensive list of optional elements. They are selected based on event triggers (e.g., ABS activated) and are added to Part 1 and sent as part of the BSM message, but are transmitted less frequently in order to conserve bandwidth. The BSM message includes only current snapshots (with the exception of path data which is itself limited to a few second's worth of past history data). As will be discussed in further detail herein, it is understood that any other type of V2X messages can be implemented, and that V2X messages can describe any collection or packet of information and/or data that can be transmitted between V2X communication devices. Further, these messages may be in different formats and include other information.

Each V2X device may also provide information indicative of the status of another vehicle or object in its proximity. For example, in one embodiment, the second passenger vehicle 110 and the sign 114 communicate by V2X communication, but the motorcycle 112 does not. The second passenger vehicle 110 and/or the sign 114 may provide information about the motorcycle 112, e.g., it's speed and location, to the HV 102.

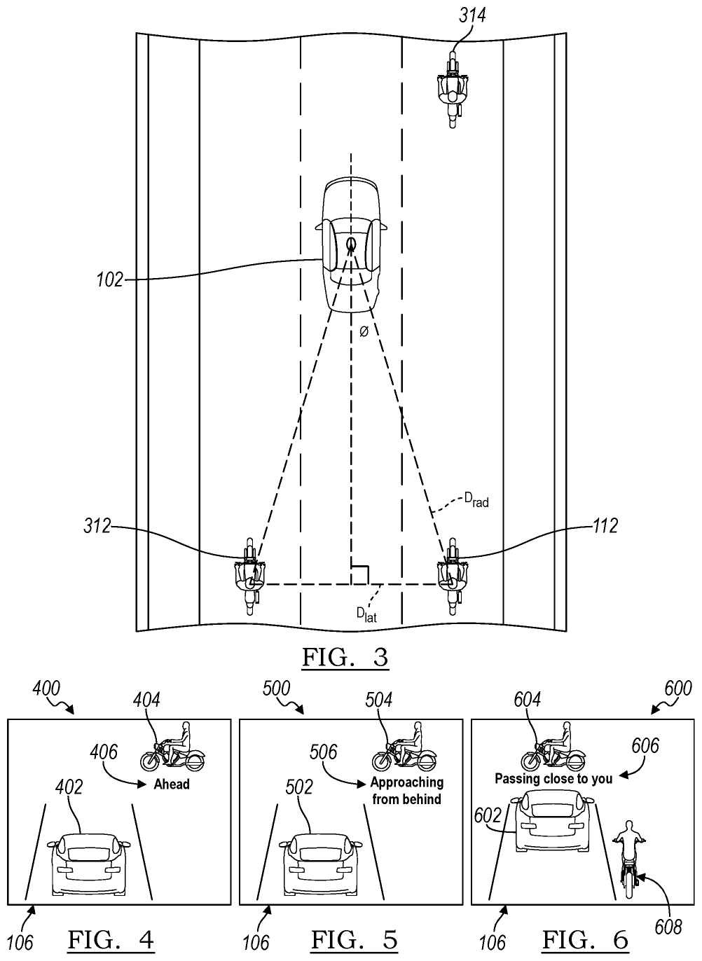

FIG. 3 is a diagram illustrating multiple motorcycles positioned relative to the HV 102. The first motorcycle 112 is illustrated behind the HV 102 and in an adjacent right lane. The position of the first motorcycle 112 relative to the HV 102 may be defined by a radial distance (D_{rad}) and a lateral offset distance (Dₗₐₜ). The radial distance (D_{rad}) refers to a distance between the center of the HV 102 and the center of the first motorcycle 112. The lateral offset distance (That) refers to a distance between a longitudinal line extending through the HV 102 along its lane and the center of the first motorcycle 112. Also illustrated in FIG. 3 is a second motorcycle 312 that is located behind the HV 102 and in an adjacent left lane, and a third motorcycle 314 that is located ahead of the HV 102 and in the adjacent right lane.

The vehicle system 100 may determine the radial distance (D_{rad}) and lateral offset distance (That) between the HV 102 and an RV based on position data from each vehicle, e.g., from global positioning system (GPS) data. For example, the vehicle system 100 may receive an X, Y, Z coordinate for each vehicle, and then calculate D_{rad} using Equation 1:

D_{rad}=\sqrt{(x_{RV}−x_{HV})²+(y_{RV}−y_{HV})²+(z_{RV}−z_{HV})²} (1)

The vehicle system 100 may then calculate That using trigonometry based on D_{rad}, e.g., Sin (θ)=Dₗₐₜ/D_{rad}. The vehicle system 100 may calculate a relative radial velocity (V_{rel_rad}) based on a change in D_{rad} over time.

The vehicle system 100 may predict if the path of RV will intersect with the path of the HV 102 if both vehicles continue on their current paths, e.g., if the RV will perform a lane-splitting maneuver. If the vehicle system 100 predicts that the RV path will intersect the HV path, the vehicle system 100 may calculate an absolute time-to-contact (TTC) between the vehicles based on the radial distance (D_{rad}) and a relative radial velocity (V_{rel_rad}) as shown in Equation 2.

TTC=abs(D_{rad}/V_{rel_rad}) (2)

Referring to FIGS. 4-6, the vehicle system 100 may provide information to the driver of the HV 102 based on the type and relative position of the RV. The vehicle system 100 may provide the RV information to the driver using the user interface 106, and/or a vehicle audio system (not shown). The vehicle system 100 may also provide different messages, based on the proximity of the RV to the HV 102. For example, the vehicle system 100 may provide an advisory message or a warning message based on the TTC.

With reference to FIG. 4, the vehicle system 100 may provide an advisory message 400 that represents an RV located ahead of the HV 102 on the user interface 106. The advisory message 400 may include an HV image 402 that represents the HV 102, an RV image 404 that indicates the type of the nearby RV vehicle, and/or an RV message 406 that indicates the position of the RV relative to the HV 102. The vehicle system 100 may determine that the RV is a motorcycle that is located ahead of and to the right of the HV 102, e.g., the third motorcycle 314 of FIG. 3. Then the vehicle system 100 may provide an RV image 404 that is in the shape of a motorcycle and/or provide an RV message 406, e.g., in text, indicating that the RV is “ahead” of the HV 102. In one or more embodiments, the position of the RV image 404 and RV message 406 on the user interface 106 may also indicate the position of the RV relative to the HV 102, e.g., the RV image 404 and RV message 406 may be located on a right side of the user interface when the RV is located to the right of the HV 102, e.g., the third motorcycle 314 is located ahead of and in an adjacent right lane relative to the HV 102, as shown in FIG. 3.

Referring to FIG. 5, the vehicle system 100 may provide an advisory message 500 that represents an RV located behind the HV 102 on the user interface 106. The advisory message 500 may include an HV image 502 that represents the HV 102, an RV image 504 that represents the RV, and/or an RV message 506, e.g., in text, that represents the relative position of the RV, e.g., the RV is “approaching from behind.” The vehicle system 100 may determine that the RV is a motorcycle that is located behind and to the right of the HV 102, e.g., the first motorcycle 112 of FIG. 3. In one or more embodiments, the position of the RV image 504 and RV message 506 on the user interface 106 relative to the HV image 502 may also indicate the position of the RV relative to the HV 102, e.g., the RV image 504 and RV message 506 may be located on a right side of the user interface when the RV is located to the right of the HV 102, e.g., the first motorcycle 112 is located behind and in an adjacent right lane relative to the HV 102, as shown in FIG. 3.

With reference to FIG. 6, the vehicle system 100 may provide a warning message 600 that represents an RV located very close to the HV 102 on the user interface 106. The warning message 600 may include an HV image 602 that represents the HV 102, an RV image 604 that represents the RV, and/or provide an RV message 606, e.g., in text, that represents the relative motion of the RV, e.g., the RV is “passing close to you.” The vehicle system 100 may determine that the RV is a motorcycle that is located behind and to the right of the HV 102, e.g., the first motorcycle 112 of FIG. 3, and preparing to pass the HV 102 closely on its right side. The user interface 106 may also provide indicia 608 that is indicative of a warning message to the driver. The warning message indicia 608 may blink or change color or be accompanied by a sound or haptic feedback to inform the driver. For example, as shown in FIG. 6, the warning message indicia 608 includes an image of a motorcycle passing on the right side of the HV image 602.

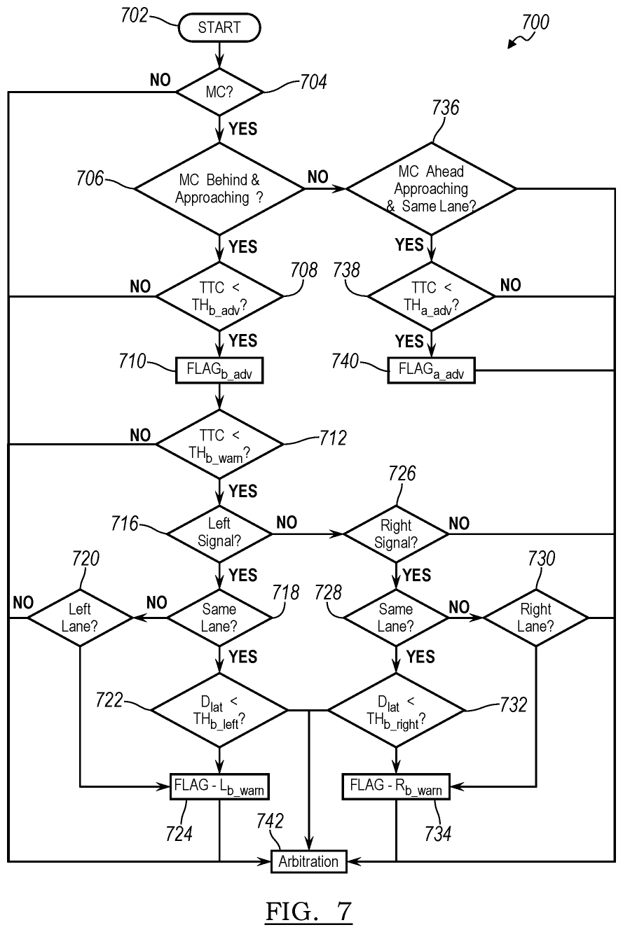

With reference to FIG. 7, a flow chart depicting a method for monitoring remote vehicles is illustrated in accordance with one or more embodiments and is generally referenced by numeral 700. The method 700 is implemented using software code that is executed by the controller 104 and contained within memory according to one or more embodiments. While the flowchart is illustrated with a number of sequential steps, one or more steps may be omitted and/or executed in another manner without deviating from the scope and contemplation of the present disclosure.

Although the controller 104 is described as a single controller, it may contain multiple controllers, or may be embodied as software code within one or more other controllers. The controller 104 generally includes any number of microprocessors, ASICs, ICs, memory (e.g., FLASH, ROM, RAM, EPROM and/or EEPROM) and software code to co-act with one another to perform a series of operations. Such hardware and/or software may be grouped together in assemblies to perform certain functions. Any one or more of the controllers or devices described herein include computer executable instructions that may be compiled or interpreted from computer programs created using a variety of programming languages and/or technologies. In general, a processor (such as a microprocessor) receives instructions, for example from a memory, a computer-readable medium, or the like, and executes the instructions. A processing unit includes a non-transitory computer-readable storage medium capable of executing instructions of a software program. The computer readable storage medium may be, but is not limited to, an electronic storage device, a magnetic storage device, an optical storage device, an electromagnetic storage device, a semi-conductor storage device, or any suitable combination thereof. The controller 104, also includes predetermined data, or “look up tables” that are stored within memory, according to one or more embodiments.

At step 702, the vehicle system 100 initializes all flags to zero and collects data on all nearby RVs. As discussed above with reference to FIG. 2, the vehicle system 100 may communicate directly with each RV, or may communicate indirectly with each RV, e.g., through a cellular network or through a separate device, e.g., the sign 114. The vehicle system 100 collects data on all nearby RVs, including data that indicates the classification of the vehicle, e.g., whether the RV is a motorcycle, passenger vehicle, commercial truck, etc. The vehicle system 100 may evaluate the accuracy of the data, e.g., whether the position data for each RV is accurate. In one or more embodiments, the vehicle system compares global positioning system (GPS) accuracy data for each vehicle to predetermined thresholds to determine if the position data is accurate. The vehicle system 100 may also calculate the position (e.g., D_{rad} and Dₗₐₜ), relative velocity (V_{rel_rad}), and time-to-contact (TTC) of each RV at step 702.

At step 704 the vehicle system 100 evaluates the vehicle classification data to determine if the RV is a motorcycle. In one embodiment, a vehicle classification value that is less than or equal to forty is indicative of a motorcycle. If the RV is a motorcycle, the vehicle system 100 proceeds to step 706

At step 706 the vehicle system 100 analyzes the position of the motorcycle relative to the HV 102 to determine if the motorcycle is behind the HV 102 and approaching, i.e., the radial distance (Drag) between the two vehicles is decreasing. If these conditions are met, the vehicle system proceeds to step 708 to start a motorcycle behind subroutine.

At step 708 the vehicle system 100 compares the TTC to a predetermined threshold value (TH_{b_adv}) that represents a minimum TTC when the RV is behind the HV before providing an advisory message. In one or more embodiments, TH_{b_adv} is equal to approximately 5-10 seconds. In another embodiment, TH_{b_adv} is equal to 8 seconds. If TTC is less than TH_{b_adv}, the vehicle system 100 proceeds to step 710 and activates a behind advisory flag (FLAG_{b_adv}), e.g., sets FLAG_{b_adv} to one.

At step 712, the vehicle system 100 compares the TTC to a predetermined threshold value (TH_{b_warn}) that represents a minimum TTC when the RV is behind the HV before providing a warning message. In one or more embodiments, TH_{b_warn} is less than TH_{b_adv} and equal to approximately 1-5 seconds. In another embodiment, TH_{b_warn} is equal to 4 seconds.

At steps 716-724, the vehicle system 100 predicts if the RV (motorcycle) is performing a lane-splitting maneuver on the left side of the HV, while the driver of the HV is preparing to switch to the left lane. At step 716, the vehicle system 100 evaluates the vehicle data to determine if the driver intends to change lanes to the left, i.e., if the HV left turn signal is on. If the left turn signal is on, the vehicle system 100 evaluates the position of the RV to determine if it is located in the same lane as the HV (step 718) or in the adjacent left lane (step 720). If the RV is located in the same lane as the HV, the vehicle system 100 proceeds to step 722 and compares the lateral offset value (That) to a threshold value (TH_{b_left}) that indicates that the motorcycle is positioned at the left side of the lane. If That is greater than TH_{b_left}, the vehicle system 100 proceeds to step 724 and activates a behind left warning flag (FLAG-L_{b_warn}). The vehicle system 100 also activates FLAG-L_{b_warn} if the vehicle system 100 determines that the RV is located in the left lane in step 720.

At steps 726-734, the vehicle system 100 predicts if the RV (motorcycle) is performing a lane-splitting maneuver on the right side of the HV, while the driver of the HV is preparing to switch to the right lane. At step 726, the vehicle system 100 evaluates the vehicle data to determine if the driver intends to change lanes to the right, i.e., if the HV right turn signal is on. If the right turn signal is on, the vehicle system 100 evaluates the position of the RV to determine if it is located in the same lane as the HV (step 728) or in the adjacent right lane (step 730). If the RV is located in the same lane as the HV, the vehicle system 100 proceeds to step 732 and compares the lateral offset value (Mat) to a threshold value (TH_{b_right}) that indicates that the motorcycle is positioned at the right side of the lane. If Dₗₐₜ is greater than TH_{b_right}, the vehicle system 100 proceeds to step 734 and activates a behind right warning flag (FLAG-R_{b_warn}). The vehicle system 100 also activates FLAG-R_{b_warn} if the vehicle system 100 determines that the RV is located in the right lane in step 730.

If, at step 706, the vehicle system 100 determines that the motorcycle is not behind the HV 102, in an adjacent right or left lane, or approaching, the vehicle system 100 proceeds to step 736 to start a motorcycle ahead subroutine. At step 736 the vehicle system 100 analyzes the position of the motorcycle relative to the HV 102 to determine if the motorcycle is ahead of the HV 102, in the same lane, and approaching, i.e., the radial distance (Drag) between the two vehicles is decreasing. If these conditions are met, the vehicle system proceeds to step 738.

At step 738 the vehicle system 100 compares the TTC to a predetermined threshold value (TH_{a_adv}) that represents a minimum TTC when the RV is ahead of the HV before providing an advisory message. In one or more embodiments, TH_{a_adv} is equal to approximately 5-10 seconds. In another embodiment, TH_{a_adv} is equal to 8 seconds. If TTC is less than TH_{a_adv}, the vehicle system 100 proceeds to step 740 and activates an ahead advisory flag (FLAG_{a_adv}), e.g., sets FLAG_{a_adv} to one.

At step 742, the vehicle system 100 arbitrates the activated flags and provides the highest priority message to the user interface 106. The vehicle system 100 prioritizes behind flags over ahead flags because it is easier for a driver to see motorcycles ahead of the HV 102 than behind the HV 102. Accordingly, the method 700 does not include ahead warning messages, according to one or more embodiments. In other embodiments, the method 700 may include ahead warning messages in certain driving conditions, e.g., heavy traffic. The vehicle system 100 evaluates the advisory flags to determine if one or more advisory flags is activated. If both a behind advisory flag and an ahead advisory flag is activated, the vehicle system 100 provides a message corresponding to the behind advisory flag to the user interface. If the behind advisory flag is activated, but no turn signal is active, e.g., a negative determination at steps 716 and 726, the vehicle system 100 provides a message corresponding to the behind advisory flag without any directionality to the user interface, e.g., the behind advisory messages shown in FIG. 5. If only one ahead advisory flag is activated, the vehicle system 100 provides a corresponding message to the user interface, e.g., the ahead advisory message shown in FIG. 4.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle-to-everything (V2X) communication system comprising:
a user interface to display content and adapted to mount within a host vehicle (HV);
at least one transceiver to receive input indicative of a motorcycle position by V2X communication, and to receive input indicative an HV position and an HV turn signal status;
a processor programmed to:
generate content on the user interface representing the HV;
determine a time-to-contact (TTC) between the HV and a motorcycle based on the input; and
generate a warning message on the user interface indicative of the motorcycle position relative to the HV in response to the HV turn signal status being active and the TTC being less than a threshold TTC value.

2. The V2X communication system of claim 1, wherein the processor is further programmed to:
determine a radial distance of the motorcycle relative to the HV based on the motorcycle position and the HV position;
determine a radial velocity of the motorcycle relative to the HV based on the radial distance; and
determine the TTC based on the radial distance and the radial velocity.

3. The V2X communication system of claim 1, wherein the at least one transceiver is adapted to receive the input indicative of the motorcycle position from: the motorcycle by vehicle-to-motorcycle (V2M) communication, a remote vehicle by vehicle-to-vehicle (V2V) communication, or infrastructure by vehicle-to-infrastructure (V2I) communication.

4. The V2X communication system of claim 1, wherein the warning message comprises at least one of an image of the motorcycle, and text describing the motorcycle position relative to the HV.

5. The V2X communication system of claim 1, wherein the processor is further programmed to generate a behind-left warning message on the user interface in response to the HV turn signal status indicating a left turn and the motorcycle position indicating that the motorcycle is located behind the HV in an adjacent left lane.

6. The V2X communication system of claim 1, wherein the processor is further programmed to generate a behind-left warning message on the user interface in response to the HV turn signal status indicating a left turn and the motorcycle position indicating that the motorcycle is located behind the HV in a left portion of a same lane.

7. The V2X communication system of claim 1, wherein the processor is further programmed to generate a behind-right warning message on the user interface in response to the HV turn signal status indicating a right turn, and the motorcycle position indicating that the motorcycle is located behind the HV in an adjacent right lane, or in a right portion of a same lane.

8. The V2X communication system of claim 1, wherein the threshold TTC value comprises a first threshold TTC value, and wherein the processor is further programmed to generate an advisory message on the user interface in response to the TTC being greater than the first threshold TTC value and less than a second threshold TTC value.

9. The V2X communication system of claim 8, wherein the processor is further programmed to generate:
an ahead advisory message on the user interface in response to the TTC being less than the second threshold TTC value and the motorcycle position indicating that the motorcycle is located ahead of the HV; and
a behind advisory message on the user interface in response to the TTC being less than the second threshold TTC value and the motorcycle position indicating that the motorcycle is located behind the HV.

10. The V2X communication system of claim 9, wherein the processor is further programmed to prioritize the behind advisory message over the ahead advisory message.

11. A vehicle communication system comprising:
at least one transceiver positioned in a host vehicle (HV) and adapted to receive input indicative of a motorcycle position by vehicle-to-everything (V2X) communication, and to receive input indicative of an HV position and an HV turn signal status;
a processor programmed to:
generate content on a user interface representing the HV;
determine a time-to-contact (TTC) between the HV and a motorcycle based on the input; and
generate a warning message on the user interface indicative of the motorcycle position relative to the HV in response to the HV turn signal status being active and the TTC being less than a threshold TTC value.

12. The vehicle communication system of claim 11, wherein the processor is further programmed to:
determine a radial distance and a radial velocity of the motorcycle relative to the HV based on the input; and
determine the TTC based on the radial distance and the radial velocity.

13. The vehicle communication system of claim 11, wherein the processor is further programmed to:
predict a right side lane-splitting maneuver based the TTC being less than the threshold TTC value, and the motorcycle position indicating that the motorcycle is located behind the HV in a right portion of a same lane or in an adjacent right lane; and
generate a behind-right warning message on the user interface in response to the HV turn signal status indicating a right turn and the predicted right side lane-splitting maneuver.

14. The vehicle communication system of claim 11, wherein the processor is further programmed to:
predict a left side lane-splitting maneuver based the the TTC being less than the threshold TTC value, and the motorcycle position indicating that the motorcycle is located behind the HV in a left portion of a same lane or in an adjacent left lane; and
generate a behind-left warning message on the user interface in response to the HV turn signal status indicating a left turn and the predicted left side lane-splitting maneuver.

15. The vehicle communication system of claim 11, wherein the processor is further programmed to generate:
an ahead advisory message on the user interface in response to the TTC being greater than the threshold TTC value and less than a second threshold TTC value, and the motorcycle position indicating that the motorcycle is located behind the HV;
a behind advisory message on the user interface in response to the TTC being greater than the threshold TTC value and less than the second threshold TTC value, and the motorcycle position indicating that the motorcycle is located ahead of the HV; and
prioritize the behind advisory message over the ahead advisory message.

16. A method for monitoring a motorcycle position comprising:
receiving input indicative of a motorcycle position by vehicle-to-everything (V2X) communication;
receiving input indicative of a host vehicle (HV) position and an HV turn signal status;
generating content on a user interface representing an HV;
determining a time-to-contact (TTC) between the HV and a motorcycle based on the input; and
generating a warning message on the user interface indicative of the motorcycle position relative to the HV in response to the HV turn signal status and the TTC being less than a threshold TTC value.

17. The method of claim 16 further comprising generating a behind-left warning message on the user interface in response to the HV turn signal status indicating a left turn and the motorcycle position indicating that the motorcycle is located behind the HV in a left portion of a same lane.

18. The method of claim 16 further comprising generating a behind-left warning message on the user interface in response to the HV turn signal status indicating a left turn and the motorcycle position indicating that the motorcycle is located behind the HV in an adjacent left lane.

19. The method of claim 16 further comprising generating at least one of an ahead advisory message and a behind advisory message on the user interface in response to the TTC being greater than the threshold TTC value and less than a second threshold TTC value.

20. The method of claim 19 further comprising prioritizing the behind advisory message over the ahead advisory message.
